(19) United States
(12) Patent Application Publication
(10) Pub. No.: US 2015/0148191 A1
(43) Pub. Date: May 28, 2015

(54) VEHICLES

(71) Applicant: RICARDO UK LTD, Shoreham-by-Sea (GB)

(72) Inventor: Simon Shepherd, Leamington Spa Warwickshire (GB)

(73) Assignee: RICARDO UK LTD, Shoreham-by-Sea (GB)

(21) Appl. No.: 14/403,837

(22) PCT Filed: May 31, 2013
(86) PCT No.: PCT/GB2013/000249

§ 371 Date: Nov. 25, 2014

(30) Foreign Application Priority Data
Jun. 1, 2012 (GB) 1209767.1

(51) Int. Cl. B60W 30/18; B60W 10/24; B60K 6/10; B60W 10/06

(52) U.S. Cl. CPC B60W 30/18127; B60W 10/06; B60W 10/24; B60K 6/105
USPC 477/183

(57) ABSTRACT

An engine-driven vehicle includes an energy recovery system (20) for recovering energy under braking of the vehicle. Under predetermined conditions, a controller selectively delivers recovered energy from a storage (24) via device (26) to motor the engine (12) above zero speed (e.g. at or above idle speed), preferably during engine fuel cut. The engine may be motored if the vehicle speed is below a threshold speed with zero torque demand for the vehicle driveline, or when the vehicle has been brought to a stop, for example. The step of delivering recovered energy to motor the engine (12) may be initiated if a door on the vehicle is opened or if a park brake on the vehicle is activated. Auxiliary systems are driven by the engine under influence of energy delivered from the energy recovery system to the engine when the vehicle is at rest. The energy recovery system may include a mechanical flywheel.

### FIELD OF THE INVENTION

The present invention relates to improvements in vehicles, more particularly, but not exclusively, to improvements in the fuel efficiency of vehicles.

Increases in the demand for and cost of traditional fuels for vehicles is driving a need for improvements in the fuel efficiency of vehicles. Various solutions have been developed, such as hybrid engines and kinetic energy recovery systems.

There is an on-going need for further improvement in the efficiency of vehicles.

According to one aspect of the invention there is provided a method of controlling a vehicle of the kind having an engine, a transmission, a driveline, a braking system and an energy recovery system, wherein the engine is operable for supplying motive power to the driveline via the transmission, the braking system is operable for braking the driveline, and the energy recovery system is operable for recovering energy under braking of the vehicle, wherein the method comprises the steps of: using the engine to supply motive power to the driveline via the transmission; using the braking system to slow down the vehicle via the driveline; and using the energy recovery system to recover energy under braking of the vehicle; further wherein the method comprises the step of selectively delivering recovered energy stored by the energy recovery system to the engine to motor the engine above zero speed.

The method has advantageous application in the reduction of fuel consumption. For example, by using recovered energy to motor the engine above zero speed (e.g. above 0 rpm), it is possible to run the engine without fuel input. This can be particularly important for passenger vehicles, such as buses, coaches and passenger trains that are required to operate a schedule of stops (e.g. to allow passengers to embark/disembark), reducing fuel consumption and emissions.

In exemplary embodiments, the step of delivering recovered energy to motor the engine is initiated under predetermined conditions. For example, the step of delivering recovered energy to motor the engine is initiated if the engine is not acting to provide motive power to the driveline. In exemplary embodiments, the step is initiated if the vehicle speed is below a threshold speed with zero torque demand for the vehicle driveline (e.g. indicated by throttle/accelerator pedal position).

The step of delivering recovered energy to motor the engine may be initiated when the vehicle has been brought to a stop, or when a vehicle stop is anticipated.

In exemplary embodiments, the vehicle is a passenger vehicle intended to make one or more dedicated stops to allow a passenger to embark or disembark from the vehicle, and wherein the step of delivering recovered energy to motor the engine occurs in line with a schedule of dedicated stops.

In exemplary embodiments, the step of delivering recovered energy to motor the engine is initiated under one or both of the following conditions: a door on the vehicle is opened, a park brake on the vehicle is activated. In other embodiments, the step of delivering recovered energy to motor the engine is initiated in response to one or more of a dedicated driver input indicative of a dedicated stop of the vehicle, a speed-based signal indicating movement of the vehicle in slow traffic (e.g. below a threshold speed of 5 km/hr), or in accordance with a pre-programmed schedule based on time, distance or location data (e.g. GPS).

In exemplary embodiments, the vehicle includes a controller (e.g. ECU) configured to monitor engine speed and/or control fuelling of the engine.

In exemplary embodiments, the energy recovery system includes an energy storage medium configured for receiving and storing energy harvested under braking, and an energy recovery system controller for controlling the delivery of power from the operation of the energy storage medium to the engine.

In exemplary embodiments, the recovered energy is used to motor the engine at or above idle speed. Typically, the engine may include an ECU or other controller programmed to cut off or prevent a supply of fuel to the engine above idle speeds, and to regulate fuel supply to maintain an idle state. Hence, using the energy recovery system to motor the engine at or above idle speeds can reduce fuel consumption of the vehicle when the vehicle is stationary (most effectively if the engine is being motored ‘above’ idle speed), without the need to stop the engine. This also leads to a reduction in emissions.

In exemplary embodiments, the recovered energy is used to motor the engine below idle speed. Typically, the engine may include an ECU or other controller programmed to supply fuel to the engine if the engine is being motored below idle speed. Accordingly, a controller may be required to communicate with or be integrated into the ECU, in order to selectively regulate, cut off or prevent the supply of fuel to the engine in those instances in which power is being delivered from the energy recovery system to the engine, in particular if the engine is being motored below idle speed.

In exemplary embodiments, the vehicle includes a controller for controlling a supply of fuel to the engine, the engine is supplied with fuel under normal drive conditions, and the controller interrupts or regulates the supply of fuel if the engine is being motored under the influence of energy delivered from the energy recovery system. In exemplary embodiments, if there is a demand for engine power to drive the transmission when the engine is being motored under the influence of energy from the energy recovery system, the controller is operable to reinstate fuelling of the engine. In such instances, it may be desirable for the controller to cease or interrupt the supply of energy from the energy recovery system to the engine. In exemplary embodiments, the controller is operable to reinstate the supply of fuel to the engine if the supply of energy from the energy recovery system is exhausted.

Exemplary embodiments are particularly applicable to vehicles where auxiliary loads must be supported when the engine is idle (e.g. to power onboard auxiliary systems having pumps, fans, generators etc), since the engine does not need to be stopped and can be used to maintain power to such auxiliary systems. In particular, exemplary embodiments can be implemented to enable recovered energy to be used to motor the engine and any associated auxiliary systems when the engine is idle, thus reducing or obviating the need for fuel consumption when the engine is idle.

In exemplary embodiments, the energy recovery system is coupled to an input shaft of the transmission via a controllable device for selectively allowing energy to be harvested by the energy recovery system. In exemplary embodiments, a controller is operable to control; the flow of energy/power via the controllable device (e.g. to harvest energy during braking, or to use the recovered energy to power the engine).

In exemplary embodiments, the energy recovery system comprises a storage medium in the form of a mechanical flywheel. In other embodiments, the energy recovery system includes a storage medium comprising one ore more of the following: capacitor, battery, accumulator. In each case, the storage medium is configured for collecting energy recovered under braking, for use in supplying the recovered energy to power the engine.

There is also provided a computer program for operating a method in accordance with the above aspect of the invention. There is further provided a vehicle control system programmed for operating a method in accordance with the above aspect of the invention. There is still further provided a bus, coach or train incorporating a control system programmed for operating a method in accordance with the above aspect of the invention.

According to another aspect of the invention, there is provided a vehicle powertrain of the kind having an engine, a transmission and a driveline, wherein the engine is arranged for supplying motive power to the driveline via the transmission, and wherein an energy recovery system is arranged for recovering energy from the powertrain during braking of the driveline, further wherein a controller is provided for selectively delivering energy from the energy recovery system to the engine for the purpose of motoring the engine at or above zero speed.

In exemplary embodiments, the powertrain includes an input shaft, and wherein the energy recovery device is arranged in communication with the input shaft, and the controller is configured to allow power to flow between the energy recovery system and the transmission in drive conditions, and to allow power to flow from the energy recovery system to the engine in neutral conditions.

In exemplary embodiments, the engine is operable for powering vehicle auxiliary systems, and wherein the powertrain is configured for driving said auxiliary systems by the engine under influence of energy delivered from the energy recovery system to the engine.

The controller may be programmed for operating a method in accordance with the first aspect of the invention.

There is still further provided a vehicle incorporating a powertrain in accordance with the above aspect of the invention.

Other aspects and features of the invention will be apparent from the claims and following description of exemplary embodiments, made by way of example with respect to the accompanying drawings, in which:

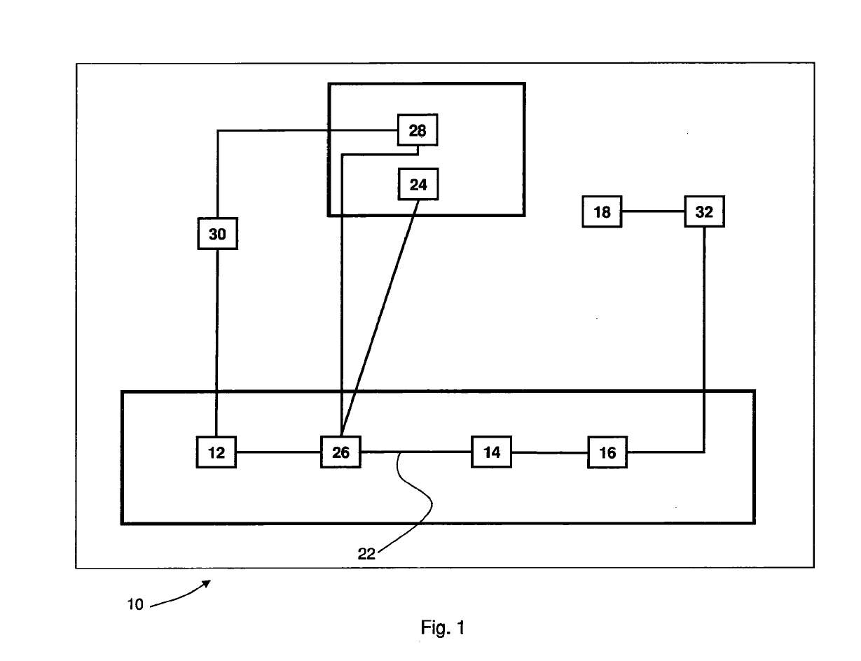

FIG. 1 is a schematic view of a vehicle having an engine, transmission and driveline, and an energy recovery device for recovering energy under braking of the vehicle;

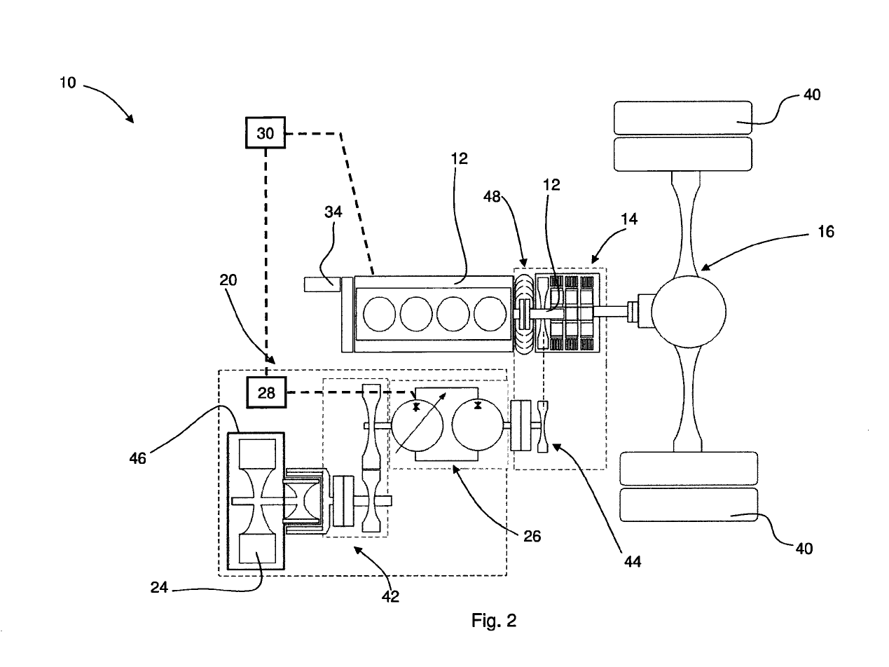

FIG. 2 is a schematic view of part of a vehicle having an automatic transmission and incorporating an energy recovery system operable to supply motive power to the vehicle engine; and

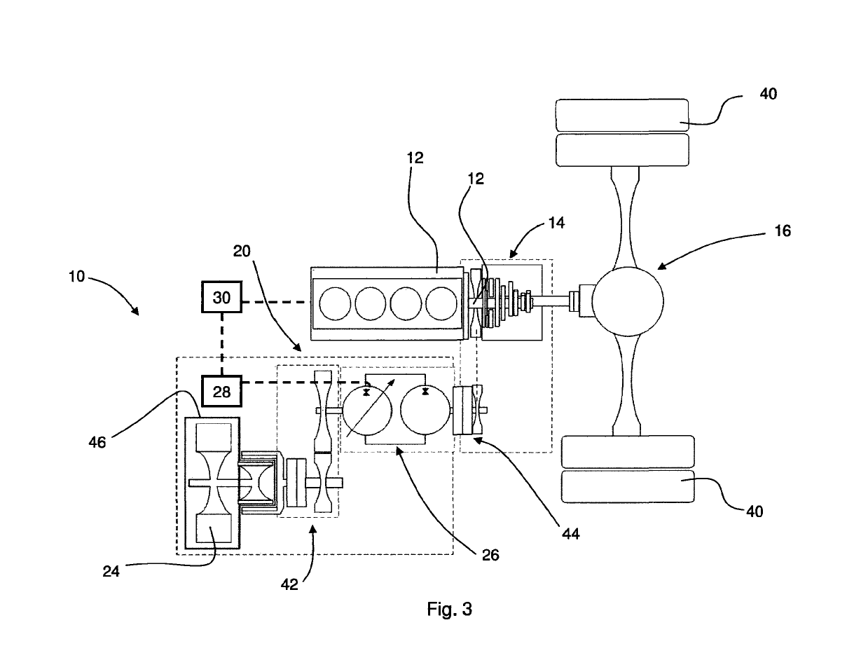

FIG. 3 is similar to FIG. 2, but shows part of a vehicle having a manual transmission and incorporating an energy recovery system operable to supply motive power to the vehicle engine.

Referring firstly to FIG. 1, a vehicle is indicated generally at 10. The vehicle 10 includes a powertrain 11 of the kind having an engine 12, transmission 14 and driveline 16. The engine 12 is arranged for supplying motive power to the driveline 16 via the transmission 14. A braking system 18 is provided for braking motion of the vehicle 10, e.g. via service brakes 32 acting on the driveline 16.

The vehicle 10 includes an energy recovery system 20 arranged for receiving energy from the powertrain 11 under braking of the vehicle 10. As will be described in more detail below, the energy recovery system 20 can also be used to motor the engine 12 above zero speed.

The energy recovery system 20 includes an energy recovery device or storage medium 24 in communication with the powertrain via a controllable device 26. In this embodiment, the controllable device 26 is arranged in communication with an input shaft 22 of the transmission 16. As will be understood, this arrangement allows power to flow from the engine to the transmission 16 (e.g. in drive conditions), and to allow energy to be harvested from the powertrain 11 by the energy recovery system 20 under braking of the vehicle 10. However, as will be described in more detail below, the arrangement can also be used for supplying power from the storage medium 24 to the engine 12, e.g. in neutral conditions.

One or more clutches or torque converters (not shown) may be included between the engine 12 and the transmission 14, as appropriate. One or more clutches (not shown) may be provided between the transmission 14 and the energy recovery system 20, as appropriate.

In exemplary embodiments, the controllable device 26 takes the form of a CVT or electrical motor arrangement connected between the storage medium 24 and the transmission 14 (e.g. via the input shaft 22 of the transmission 14). In such embodiments, the storage medium 24 will usually take the form of a mechanical flywheel, wherein the CVT or electrical motor arrangement is configured for controlling the recovery and delivery of energy between the flywheel 24 and the powertrain 11. In other embodiments, the storage medium 24 may take the form of a supercapacitor for storing electrical energy converted and recovered from kinetic energy under braking, or may take the form of a hydraulic accumulator or a battery, for example. In each case, the storage medium 24 is configured for selectively supplying recovered energy to the engine 12.

Recovery systems of the kind referred to in the above paragraph are known in the art and will not be described in detail here. Also, CVTs, electrical motor arrangements and other mechanisms suitable for controlling torque transfer between an energy store and a powertrain are known and will not be described in detail here.

It will be understood that the energy recovery system 20 is configured to harvest vehicle kinetic energy whilst the vehicle 10 is braking. In conventional energy recovery systems using a flywheel, part of the recovered energy is often wasted, e.g. due to losses as the flywheel coasts down during the delay between braking and a subsequent demand for the recovered energy. The energy recovery system 20 can be used to mitigate this problem. In particular, the energy recovery system includes a recovery system controller 28 programmed for controlling a delivery of power from the flywheel 24, via the controllable device 26, to the engine 12 using energy harvested under braking. Given that energy will often be recovered when the vehicle is being brought to a stop, energy recovered under braking will often be used almost immediately. Advantageously, the energy recovery system 20 thereby eliminates or reduces the need for fuelling of the engine 12 when the vehicle 10 is stopped, for example.

In exemplary embodiments, the controller 28 is programmed for delivering power from the energy recovery system 20 to the engine under predetermined conditions, e.g. if the engine 12 is being motored within predefined limits (e.g. below a threshold speed) with zero driver/torque demand.

In exemplary embodiments, the energy recovery system 20 is used to motor the engine at or above idle speed.

Typically, the engine 12 will include an ECU 30 programmed to cut off or prevent a supply of fuel to the engine 12 above idle speeds. Hence, motoring the engine above idle speeds obviates the need for active fuelling. Typically, the ECU will also be programmed to regulate fuelling at idle speed, in order to prevent stalling of the engine. Hence, if the engine motored at idle speeds, the need for active fuelling may be minimised. It will be appreciated, therefore, that the energy recovery system 20 can be used to reduce fuel consumption and emissions when the vehicle is stationary, without the need to stop the engine 12.

Since conventional ECUs are typically programmed to supply fuel to the engine 12 if the engine is being motored below idle speed, it may be necessary for the controller 28 to communicate with (or be integrated into) the ECU 30, in order to selectively cut-off or prevent the supply of fuel to the engine 12 in those instances in which power is being delivered from the energy recovery system 20 to the engine 12, in particular if the engine 12 is being motored below idle speed.

Advantageously, the energy recovery system 20 enables the vehicle to be brought to a stop without needing to stop the engine 12 or without maintaining a fuel supply to the engine 12. Hence, the system 20 overcomes durability issues associated with conventional stop-start solutions for reducing fuel consumption, because the engine 12 remains motored (e.g. at or above idle speed, to avoid stalling). This makes the system 20 particularly advantageous for heavy-duty commercial vehicles such as buses and trains, which are prone to making regular or scheduled stops and where conventional stop-start systems are less desirable.

The system is further advantageous in that it allows engine driven auxiliary systems to remain functional during idle or ‘vehicle stopped’ situations, thereby reducing or avoiding the need to provide electrical power for such auxiliary systems (as is typically the requirement for vehicles which operate on conventional stop-start systems). In exemplary embodiments, the recovered energy can be used to power the auxiliary systems.

For systems having a flywheel as the energy storage medium 24 in particular, the energy recovery system 20 affords very efficient use of recovered energy, as the energy recovery system 20 is ideally configured to utilise the flywheel charge immediately as the vehicle 10 comes to a stop (or as the vehicle coasts down to a stop, e.g. below a vehicle speed of 5 km/h), thus minimising self-discharge in the flywheel.

The system 20 is ideally suited for retro-fit applications, since the level of engine integration required to operate the system will be minimal in most cases, such as where an existing engine ECU is already configured to monitor engine status and operate a ‘fuel cut’ mode if the engine is being motored by the gearbox when the vehicle is coasting with zero driver demand and is not at risk of stalling.

A method of operating an energy recovery system of the kind described above will now be described with reference to FIG. 2.

A vehicle 10 has an engine 12 arranged for supplying motive power to wheels 40 of the vehicle driveline 16, via an automatic transmission 14. The vehicle includes an energy recovery system 20, in which a flywheel 24 communicates with an input shaft 22 of the transmission 14 via a CVT 26. A high speed disconnect clutch 42 is provided for communication between the flywheel 24 and the CVT 26, and a low speed disconnect clutch 44 is provided for communication between the CVT 26 and the transmission 14. In the illustrated embodiment, the flywheel 24 is mounted in a vacuum chamber 46, and drive is transmitted to/from the flywheel via a magnetic coupling of known construction (to minimise mechanical losses). A torque converter and lock up clutch 48 is provided between the engine 12 and the transmission 14.

If the vehicle 10 is travelling under driven conditions (e.g. the wheels 40 are receiving motive power from the engine 12 via the transmission 14) and braking is required:
the driver lifts off throttle at speed and coasts; or
the driver lifts off throttle at speed and applies braking force (e.g. via service brakes).

Under these braking conditions, the energy recovery system 20 is configured to allow the storage medium 24 to recover energy from the transmission 14, via the CVT and associated clutches 42, 44.

Under such braking conditions, the automatic transmission 14 downshifts according to its automatic shift schedule. It will be understood that manual downshift may be required in embodiments having manual transmissions, e.g. as shown in FIG. 3.

If a dedicated stop is detected or anticipated, e.g. for the purpose of allowing the vehicle 10 to come to rest at a passenger embarkation/disembarkation location or as a result of traffic congestion (over and above a momentary stop), an energy recovery controller 28 (forming part of the energy recovery system 20) is operable to initiate the supply of recovered energy from the storage medium 24 to the engine 12.

A dedicated stop (as opposed to a momentary stop) may be indicated by a vehicle door being opened or indicated by a park brake command or other command from the driver indicative of a non-momentary stop, for example. Other inputs for the controller 28 to initiate delivery of power from the energy recovery system 20 to the engine 12 may include a speed-based signal indicating movement of the vehicle in slow traffic (e.g. below a threshold speed of 5 km/hr), or in accordance with a pre-programmed schedule based on time, distance or location data (e.g. from GPS) for the vehicle.

In the illustrated embodiment, the controller 28 is configured to command the transmission 14 to select neutral. This disengages drive to wheels 40 of the driveline 16. At that point, the controller 28 is configured to permit the recovered energy to be utilised to drive the engine 12 (e.g. through the CVT 26 and torque converter and lock-up clutch 48) to motor the engine 12. In exemplary embodiments, the controller 28 is operable to motor the engine 12 at or above idle speed. Advantageously, this eliminates the need for fuelling of the engine 12 when in an idle state.

It will be understood that the step of selecting neutral is required if the storage medium 24 is connected to the powertrain via the transmission input 22, but is not required in embodiments where the storage medium 24 is arranged for communication on the engine side of a launch device (e.g. on the engine side of the torque converter and lock up clutch 48) between the engine 12 and the transmission 14.

If a restart is detected (e.g. indicated by a door being closed, the driver selecting a drive command, or releasing the park brake etc), the controller 28 will cease communication between the engine 12 and the storage medium 24. In exemplary embodiments, the ECU 30 will then automatically reinstate fuelling of the engine (e.g. if a stalling condition is detected/anticipated). This may also be the case if the supply of energy from the storage medium 24 is exhausted (or exhaustion is anticipated, e.g. of the level of energy drops below a predefined threshold). However, in other embodiments, the controller 28 may communicate with the ECU 30 to actively reinstate fuelling, if necessary, e.g. after or in anticipation of the supply of energy from the storage medium being exhausted or interrupted for a restart operation.

If charge remains in the energy store 24, this can be used to assist re-launch.

Where necessary in the event of restart being detected or if the energy in the storage medium 24 is exhausted (e.g. in embodiments where the storage medium is connected to the transmission input), the controller 28 is configured to switch the powertrain 11 back to a state which allows the vehicle to re-launch under power from the engine.

As will be understood from the above description, the energy recovery system 20 provides an ‘idle fuel cut’ function in which vehicle kinetic energy can be harvested into an energy store 24 during normal braking events and the captured can be re-used to avoid the need for a stop-start operation of the engine 12.

In exemplary embodiments, the system 20 detects when the vehicle comes to rest, e.g. in response to driver and/or vehicle inputs, and is operable to use the recovered energy to motor the engine 12 without driving the vehicle driveline (e.g. during dedicated ‘stop’ periods). Engine speed is maintained by the system 20 during stop periods, so that the engine 12 is no longer required to burn fuel to prevent stalling.

Advantageously, operation of auxiliary systems (indicated generally at 34) that are normally powered by the engine 12 (e.g. onboard systems having one or more fans, generators, pumps etc) can be maintained without electrical assistance during stop periods by virtue of the fact that the engine 12 is still running (e.g. at or above idle speed).

Advantageously, limited engine control integration may be required by the system 20, since many conventional engine control systems are already configured to detect changes in driving conditions (e.g. vehicle coast down). Hence, the system 20 provides a straightforward retro-fit opportunity.

The system 20 allows recovered energy to be used to provide power back to the engine (not the driveline) during stop periods, thus eliminating the need to burn fuel to maintain idle speed and drive auxiliary systems. Hence, the engine can be allowed to remain running, avoiding the need for re-starts. It will be understood that restarting the engine requires high peak torques to over come the initial pumping loads in the engine. If the engine is already running (in accordance with the system 20), these torques are much lower.

In addition to providing support for the engine during ‘stopped’ or idle conditions, the energy recovery system 20 can also be used to utilise recovered energy from the storage medium 24 to support down shifting operation(s) and maintain the engine 12 in a fuel-cut mode, and/or to make over-run torque acceptable if engine over-run torque is high.

In accordance with conventional engine management systems, the ECU 30 is operable to switch from a ‘fuel’ mode (i.e. in which fuel is supplied to the engine 12) to a ‘fuel cut’ mode (i.e. in which the fuel supply to the engine is regulated or interrupted) under predefined drive conditions, e.g. if the engine is being motored above an idle state.

In the majority of instances, it will be understood that the step of delivering recovered energy to motor the engine is initiated if the engine is not acting to provide motive power to the driveline, or if the vehicle speed is below a threshold speed with zero torque demand for the vehicle driveline (e.g. indicated by throttle/accelerator pedal position).

The embodiment of FIG. 3 is similar to FIG. 2, but includes a manual transmission. ther layout of the powertrain and operation of the recovery system in harvesting energy under braking and supplying recovered energy to motor the engine is substantially the same as described with reference to FIGS. 1 and 2, and so is not discussed here. Corresponding reference numerals have been used to mirror FIGS. 1 and 2. A torque converter and lock up clutch 48 is not included in this embodiment, but may be included as appropriate. Similarly, engine-driven auxiliary systems 34 are not illustrated but may be included, if desired.

Although described with primary reference to commercial passenger vehicles such as buses, coaches or passenger trains, the invention may be implemented in other types of engine-driven vehicles, such as passenger cars, agricultural plant and other off-highway plant where energy is recoverable under braking and engine stop-start functions are can be avoided.

1. A method of controlling a vehicle of the kind having an engine, a transmission, a driveline, a braking system and an energy recovery system, wherein the engine is operable for supplying motive power to the driveline via the transmission, the braking system is operable for braking the driveline, and the energy recovery system is operable for recovering energy under braking of the vehicle,
wherein the method comprises the steps of: using the engine to supply motive power to the driveline via the transmission; using the braking system to slow down the vehicle via the driveline; and using the energy recovery system to recover energy under braking of the vehicle;
further wherein the method comprises the step of selectively delivering recovered energy stored by the energy recovery system to the engine to motor the engine above zero speed.

2. The method according to claim 1 wherein the step of delivering recovered energy to motor the engine is initiated under predetermined conditions.

3. The method according to claim 2 wherein the step of delivering recovered energy to motor the engine is initiated if the engine is not acting to provide motive power to the driveline, or if the vehicle speed is below a threshold speed with zero torque demand for the vehicle driveline (e.g. indicated by throttle/accelerator pedal position).

4. The method according to claim 1 wherein the step of delivering recovered energy to motor the engine is initiated when the vehicle has been brought to a stop, or when a vehicle stop is anticipated.

5. The method according to claim 1 wherein the vehicle is a passenger vehicle intended to make one or more dedicated stops to allow a passenger to embark or disembark from the vehicle, and wherein the step of delivering recovered energy to motor the engine occurs in line with a schedule of dedicated stops.

6. The method according to claim 1 wherein the step of delivering recovered energy to motor the engine is initiated under one or both of the following conditions: a door on the vehicle is opened, a park brake on the vehicle is activated.

7. The method according to claim 1 wherein the step of delivering recovered energy to motor the engine is initiated in response to one or more of a dedicated driver input indicative of a dedicated stop of the vehicle, a speed-based signal indicating movement of the vehicle in slow traffic (e.g. below a threshold speed of 5 km/hr), or in accordance with a preprogrammed schedule based on one or more of time, distance or location data, e.g. GPS.

8. The method according to claim 1 wherein the recovered energy is used to motor the engine at or above idle speed.

9. The method according to claim 1, wherein the vehicle includes a controller for controlling a supply of fuel to the engine, the engine is supplied with fuel under normal drive conditions, and the controller stops or regulates the supply of fuel if the engine is being motored under the influence of energy delivered from the energy recovery system.

10. The method according to claim 9 wherein, if there is a demand for engine power to drive the transmission when the engine is being motored under the influence of energy from the energy recovery system, the controller is operable to provide active fuelling of the engine.

11. The method according to claim 9 wherein the controller is operable to reinstate active fuelling to the engine if the supply of energy from the energy recovery system is exhausted.

12. The method according to claim 1 wherein the vehicle includes auxiliary systems and said auxiliary systems are driven by the engine under influence of energy delivered from the energy recovery system to the engine when the vehicle is at rest.

13. The method according to claim 1 wherein the energy recovery system comprises an energy storage medium for collecting energy recovered under braking, and wherein a controllable device provides for selective communication between the energy storage medium and the engine.

14. The method according to claim 13 wherein the controllable device is arranged for communication with an input shaft of the transmission for selectively allowing energy to be collected by the energy storage medium under braking.

15. The method according to claim 1 wherein the energy recovery system comprises a mechanical flywheel, or one or more of the following: capacitor, battery, accumulator.

16. A vehicle powertrain of the kind having an engine, a transmission and a driveline, wherein the engine is arranged for supplying motive power to the driveline via the transmission, and wherein an energy recovery system is arranged for recovering energy from the powertrain during braking of the driveline,
further wherein a controller is provided for selectively delivering energy from the energy recovery system to the engine for the purpose of motoring the engine at or above zero speed.

17. The vehicle powertrain according to claim 16 wherein the engine is operable for powering vehicle auxiliary systems, and wherein the powertrain is configured for driving said auxiliary systems by the engine under influence of energy delivered from the energy recovery system to the engine.

18. The vehicle powertrain according to claim 16 wherein the energy recovery system comprises a storage medium in the form of a mechanical flywheel, or one or more of the following: capacitor, battery, accumulator.

19. The vehicle powertrain according to claim 16 wherein the energy recovery system comprises an energy storage medium for collecting energy recovered under braking, and wherein a controllable device provides for selective communication between the energy storage medium and the engine.

20. The vehicle powertrain according to claim 19 wherein the controllable device is arranged for communication with an input shaft of the transmission for selectively allowing energy to be collected by the energy storage medium under braking.
